(19) United States
(12) Patent Application Publication
(10) Pub. No.: US 2023/0370272 A1
(43) Pub. Date: Nov. 16, 2023

(54) BLOCKCHAIN-BASED DIGITAL ASSET ACCESS METHOD, ELECTRONIC DEVICES, AND NON-TRANSITORY COMPUTER-READABLE MEDIA UTILIZING THE METHOD

(71) Applicant: International Trust Machines Corporation, New Taipei (TW)

(72) Inventor: GWAN-HWAN HWANG, New Taipei (TW)

(21) Appl. No.: 18/196,608

(22) Filed: May 12, 2023

Related U.S. Application Data
(60) Provisional application No. 63/364,714, filed on May 13, 2022.

(51) Int. Cl. H04L 9/32

(52) U.S. Cl. CPC H04L 9/3234; H04L 9/3247; H04L 9/3213

(57) ABSTRACT

A blockchain-based digital asset access method is provided. The method includes: receiving an access request for a digital token from a user, with the digital token corresponding to a digital asset; examining the user's rights to the digital token according to the access request; obtaining the digital asset and its corresponding attestation result based on the rights of the user; verifying the obtained digital asset with the blockchain using the attestation result, to obtain a verification result; and determining whether to perform an operation corresponding to the digital asset based on the verification result. In addition, an electronic device and a non-transitory computer-readable medium utilizing the aforementioned method are also disclosed.

### CROSS-REFERENCE TO RELATED APPLICATION

The present application claims the benefit of and priority to U.S. Provisional Patent Application Ser. No. 63/364,714, filed on May 13, 2022, entitled “METHOD, DEVICE AND SYSTEM FOR PRESENTING NON-FUNGIBLE TOKENS,” the contents of which are hereby incorporated herein fully by reference into the present application for all purposes.

### FIELD

The present disclosure generally relates to digital token applications, and more specifically, to a blockchain-based digital asset access method as well as electronic devices and computer program products utilizing the method.

### BACKGROUND

Non-Fungible Tokens (NFTs) are digital data based on blockchain technology. Due to their indivisible and non-replicable characteristics, NFTs are often used as certificates of ownership or naming rights for digital assets, such as paintings and audiovisual materials.

Although NFTs may be suitable as means for ownership or naming rights of digital assets, they have also caused issues, such as copyright thefts in digital assets. Furthermore, since ownership or naming rights cannot prevent mass replication or unauthorized reuse of the digital assets themselves, the value of these rights cannot be truly demonstrated.

### SUMMARY

In view of the above, the present disclosure provides a blockchain-based digital asset access method and electronic devices and non-transitory computer-readable media utilizing this method, which can manage the use of digital assets, prevent copyright thefts of digital assets, and thereby demonstrate and enhance the value of digital assets.

In a first aspect of the present disclosure, a blockchain-based digital asset access method is provided. The method includes receiving an access request for a digital token corresponding to a digital asset from a user; examining a right of the user to the digital token according to the access request; obtaining the digital asset and an attestation result corresponding to the digital asset according to the right of the user; verifying the obtained digital asset with a blockchain according to the attestation result, to obtain a verification result; and determining whether to perform an operation corresponding to the digital asset based on the verification result.

In a second aspect of the present disclosure, an electronic device is provided. The electronic device includes a communication module, a memory storing at least one instruction, and a processor coupled to the communication module and the memory. When at least one instruction is executed by the processor, the processor causes the electronic device to receive an access request for a digital token corresponding to a digital asset from a user; examine a right of the user to the digital token according to the access request; obtain the digital asset and an attestation result corresponding to the digital asset according to the right of the user; verify the obtained digital asset with a blockchain according to the attestation result, to obtain a verification result; and determine whether to perform an operation corresponding to the digital asset based on the verification result.

In a third aspect of the present disclosure, a non-transitory computer-readable medium of an electronic device storing at least one instruction. When at least one instruction is executed by a processor of the electronic device, the processor causes the electronic device to receive an access request for a digital token corresponding to a digital asset from a user; examine a right of the user to the digital token according to the access request; obtain the digital asset and an attestation result corresponding to the digital asset according to the right of the user; verify the obtained digital asset with a blockchain according to the attestation result, to obtain a verification result; and determine whether to perform an operation corresponding to the digital asset based on the verification result.

### BRIEF DESCRIPTION OF THE DRAWINGS

Aspects of the present disclosure are best understood from the following detailed description when read with the accompanying figures. Various features are not drawn to scale. Dimensions of various features may be arbitrarily increased or reduced for clarity of discussion.

FIG. 1 is a schematic diagram illustrating a method for minting Non-Fungible Tokens (NFTs), according to an example implementation of the present disclosure.

FIG. 2 is a flowchart illustrating a method for minting NFTs, according to an example implementation of the present disclosure.

FIG. 3 is a schematic diagram illustrating a method for accessing digital assets, according to an example implementation of the present disclosure.

FIG. 4 is a flowchart illustrating a method for accessing digital assets, according to an example implementation of the present disclosure.

FIG. 5A is a block diagram illustrating an electronic device, according to an example implementation of the present disclosure.

FIG. 5B is a block diagram illustrating an electronic device, according to another example implementation of the present disclosure.

FIG. 6 is a schematic diagram illustrating an electronic device, according to an example implementation of the present disclosure.

### DESCRIPTION

The following will refer to the related drawings to illustrate implementations of a blockchain-based method for accessing digital assets, as well as an electronic device and a non-transitory computer-readable medium performing this method. The same components will be denoted by the same reference symbols.

The following description includes specific information about the disclosed implementations of the present disclosure. The drawings and their accompanying detailed description in this disclosure are provided for illustrative purposes only and are not intended to limit the scope of the present disclosure. Those skilled in the art will recognize that other variations and implementations of the present disclosure are possible. Additionally, the drawings and examples in this disclosure are generally not drawn to scale and are not intended to correspond to actual relative sizes.

The term “couple” as used herein is defined as connected, whether directly or indirectly, through intervening components, and is not necessarily limited to physical connections. When the terms “comprise” or “include” are used in this disclosure, they mean “including but not limited to,” and explicitly indicate an open-ended relationship between the elements or groups of elements referenced.

In general, digital tokens can be classified as fungible tokens and non-fungible tokens (NFTs). Fungible tokens, for example, have characteristics that are interchangeable, identical, and divisible, while NFTs have characteristics that are indivisible, non-interchangeable, and unique. In the implementations of this disclosure, digital tokens will be illustrated using NFTs. However, it should be noted that in other implementations of this disclosure, digital tokens may be implemented using fungible tokens.

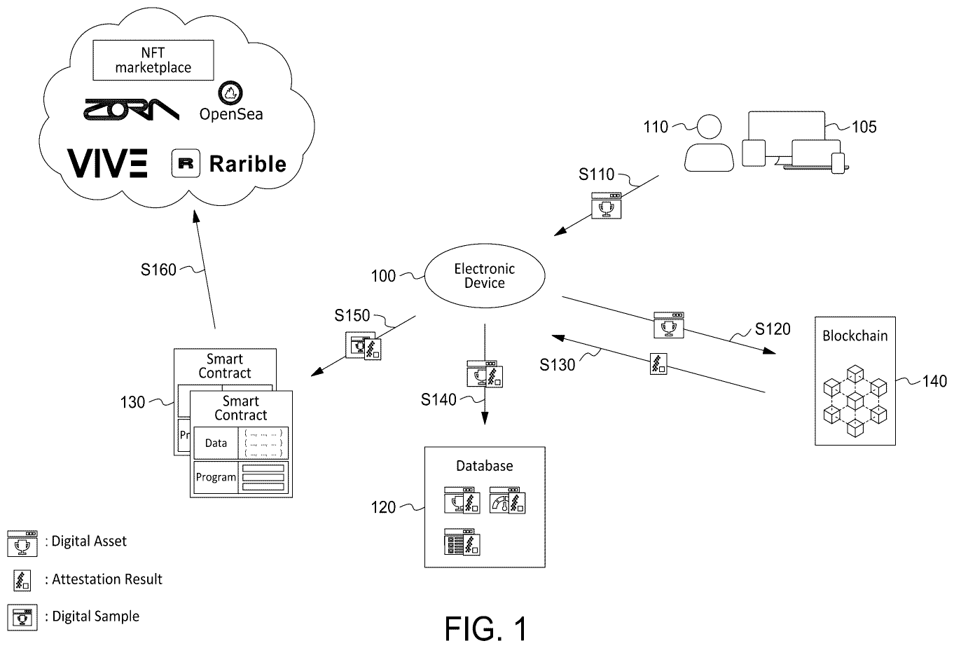

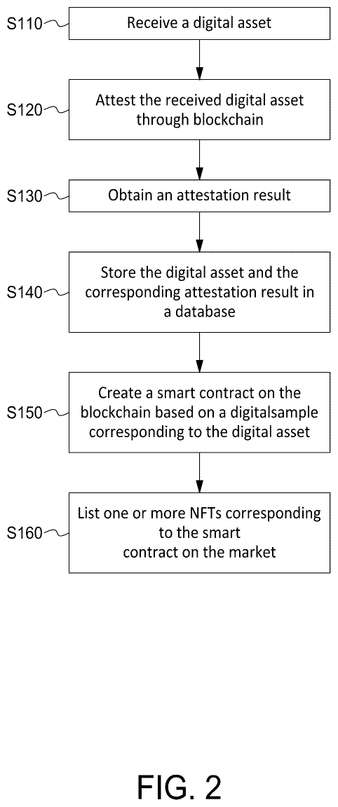

FIG. 1 is a schematic diagram illustrating a method for minting Non-Fungible Tokens (NFTs), according to an example implementation of the present disclosure. FIG. 2 is a flowchart illustrating the method for minting NFTs, according to an example implementation of the present disclosure.

Referring to FIGS. 1 and 2, electronic device 100 may be configured to implement the method for minting NFTs. In some implementations, electronic device 100 may be a server device used to mint NFTs.

In step S110 of FIG. 2, electronic device 100 may receive a digital asset. Specifically, user 110 (e.g., the creator of the digital asset) may send the digital asset to electronic device 100 for minting the digital asset into an NFT. The digital asset may include any type of digital creative work, digital document or data, and the present disclosure is not limited to any particular type of digital asset.

In some implementations, user 110 may generate an electronic signature for user 110 based on the digital asset, and then send the digital asset and the electronic signature together to electronic device 100.

For example, electronic device 105 of user 110 may first perform a specific operation (e.g., computing a hash value) on the digital asset, and then encrypt it with user 110's private key to form the electronic signature. Next, user 110 (e.g., electronic device 105 of user 110) may send the digital asset and the electronic signature to electronic device 100.

In some implementations, the digital asset may include at least one of books, music, paintings, animations, and/or software.

In some implementations, the digital asset may include digital data corresponding to a specific electronic device, such as a warranty or warranty record for a specific electronic device.

In some implementations, electronic device 100 does not limit the data size of the digital asset it receives. In other words, the digital asset can be an entire novel, high-quality audio file, or high-resolution image data of, for example, a painting or an animation, and so on.

In step S120, electronic device 100, after receiving the digital asset, may attest it through blockchain 140 and obtain an attestation result in step S130.

It should be noted that the present disclosure does not limit the type of blockchain used for attestation, which can be, for example, a public blockchain, a private blockchain, or a combination of public and private blockchains. In addition, those skilled in the art would understand that the attestation result can verify the authenticity of digital assets through the blockchain previously used for attestation. Therefore, the present disclosure does not limit the specific information and structure of the attestation result.

In some implementations, in addition to receiving the digital asset, electronic device 100 may also receive an electronic signature from user 110 (e.g., from electronic device 105 of user 110). Therefore, after verifying the electronic signature, electronic device 100 may attest the digital asset and the electronic signature together through blockchain 140.

For example, electronic device 100 may use a specific operation (e.g., calculating a hash value) to obtain a first result for the received digital asset, use public key to decrypt the received electronic signature to obtain a second result, and compare the first result with the second result to determine whether the verification is successful. If the verification is successful (e.g., the first result matches the second result), electronic device 100 may further attest the digital asset and the electronic signature together through blockchain 140. Otherwise, electronic device 100 may reply to user 110 with a message, for example, notifying user 110 of a verification failure.

In some implementations, after using a specific operation (e.g., calculating a hash value) on the digital asset (and the electronic signature), electronic device 100 may store a combination of a search key value and the operation result in a smart contract on blockchain 140 to complete attestation. The attestation result obtained by electronic device 100 may include an identification of the smart contract and the search key value. In some examples, the attestation result may also include a timestamp of the attestation and the public key and/or wallet address of a party attesting the digital asset (e.g., the attester), but the present disclosure is not limit to this type of attestation.

In some implementations, electronic device 100 may send the digital asset (and the electronic signature) to a third-party blockchain attestation platform to attest the digital asset through blockchain 140 and obtain the corresponding attestation result.

For example, the third-party blockchain attestation platform may be a platform that uses traditional technologies, such as the ones discussed in Taiwanese patent publication numbers 1783441, 1728899, 1708154, 1707573, 1706662, the contents of all of which are hereby incorporated herein fully by reference, to conduct the attestation through a public blockchain, which may have advantages, such as a lower attestation cost and faster verification speed. In this case, the attestation result may include a slice of a binary tree, which may include, at least, the hash value of the digital asset, an attestation timestamp, and the public key and/or wallet address of the party attesting the digital asset (e.g., the attester) in the leaf node.

In steps S110, S120, and S130, electronic device 100 may attest the received digital asset (and electronic signature) through blockchain 140 and obtain the corresponding attestation result. However, in some implementations, user 110 may attest the digital asset (and electronic signature) through blockchain 140 and obtain the corresponding attestation result, and then send the digital asset (and electronic signature) and the corresponding attestation result to electronic device 100.

After obtaining the digital asset (and electronic signature) and the corresponding attestation result, electronic device 100 may proceed to step S140.

In step S140, electronic device 100 may store the digital asset (and electronic signature) and the corresponding attestation result in database 120.

In step S150, electronic device 100 may create smart contract 130 on blockchain 140 based on a digital sample corresponding to the digital asset. Specifically, the digital sample corresponding to the digital asset may be used to provide a preview of the digital asset, and thus, the data size of the digital sample may be smaller than that of the digital asset. More specifically, when creating smart contract 130 corresponding to the digital asset, electronic device 100 may be minting one or more NFTs corresponding to the digital asset. That is, electronic device 100 may create smart contract 130 that may mint one or more NFTs corresponding to the digital asset. Advantageously, when creating smart contract 130 corresponding to the digital asset, electronic device 100 may not directly use the digital asset, but may use a digital sample with a smaller data size (e.g., less than 20 MB), which may effectively prevent copyright theft issues.

In some implementations, electronic device 100 may use the digital sample corresponding to the digital asset and the attestation result corresponding to the digital asset to establish smart contract 130 on blockchain 140.

In some implementations, electronic device 100 may generate the digital sample corresponding to the digital asset using the digital asset itself.

For example, when the digital asset is a high-quality audio file or a high-resolution image or animation, electronic device 100 may sample or compress the digital asset into a low-quality audio file or a low-resolution image or animation to provide a preview as the digital sample.

For example, when the digital asset is a book or a document, electronic device 100 may extract a portion of the book or document (e.g., such as the table of contents or a specific number of pages) to provide a preview as the digital sample.

In some implementations, the digital sample corresponding to the digital asset may also be received from user 110. Specifically, in addition to sending the digital asset to electronic device 100, user 110 (or user's device 105) may also send the digital sample corresponding to the digital asset to the electronic device 100.

In some implementations, the generated smart contract may be used to record the NFT's owner information (e.g., such as a wallet address), a token identifier, and description webpage information of the digital asset (e.g., such as a URL). For example, electronic device 100 may use the ERC1155 standard to create smart contract 130. However, the present invention is not limited to this, and electronic device 100 may also use other standards, such as the ERC721 standard, to generate smart contract 130.

In step S160, electronic device 100 may list one or more NFTs corresponding to smart contract 130 on the market.

In some implementations, electronic device 100 may list one or more NFTs corresponding to smart contract 130 on an NFT marketplace. Users may trade or transfer one or more NFTs on the NFT marketplace.

For example, the NFT marketplace may include any secondary market, such as OpenSea or Ramble, etc., but the present invention is not limited to such markets.

In some implementations, users may directly trade or transfer one or more NFTs using a blockchain browser, such as Etherscan, or other browsers.

In some implementations, after smart contract 130 is created in step S150, smart contract 130 may be automatically listed on the NFT marketplace. In such a case, it is not necessary to execute step S160.

Based on the above method, user 110 can mint one or more NFTs from digital assets and list them on the marketplace through electronic device 100. Advantageously, since smart contract 130 corresponding to one or more NFTs is created using a digital sample, the content of the digital sample may only be for preview through the description webpage and may not be directly accessed or copied to prevent theft.

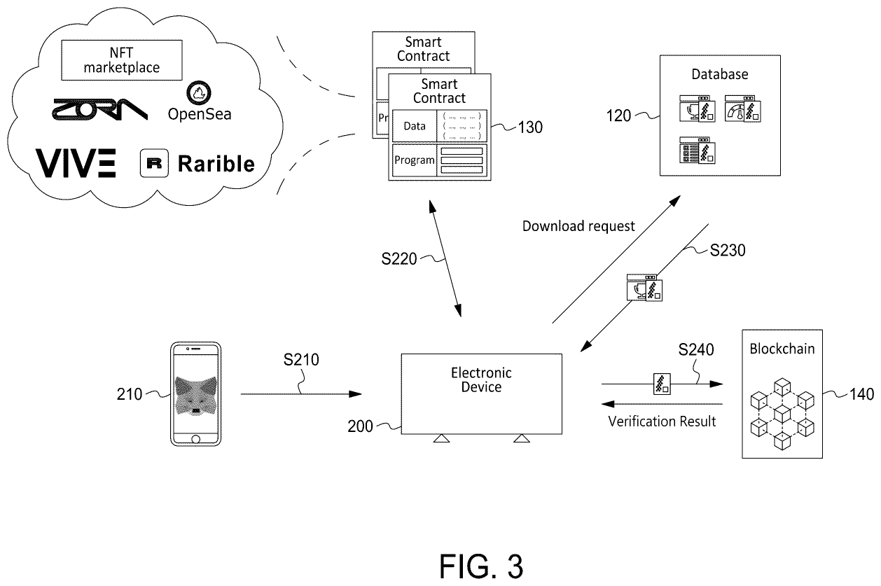

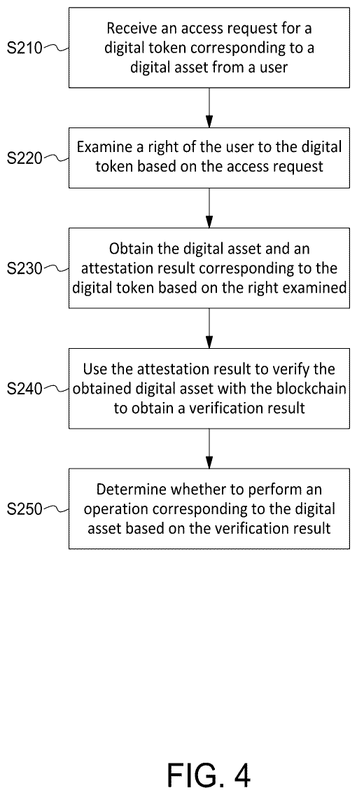

FIG. 3 is a schematic diagram illustrating a method for accessing digital assets, according to an example implementation of the present disclosure. FIG. 4 is a flowchart illustrating the method for accessing digital assets, according to an example implementation of the present disclosure.

Referring to FIGS. 3 and 4, electronic device 200 may be configured to determine whether user 210 has the right to access the digital asset, and the operation corresponding to the digital asset may be executed after the digital asset verified by the blockchain is obtained (the details of which are described below).

In step S210, electronic device 200 may receive, for example, from user 210 (or user's device 210), an access request for a digital token corresponding to a digital asset. Specifically, user 210 may send an access request to electronic device 200, which may indicate the digital token and the smart contract corresponding to the digital token.

In some implementations, the access request may include information about user 210 (e.g., such as wallet address), the token identifier, and the address of the smart contract corresponding to the digital asset. In some implementations, the access request may also include an electronic signature of user 210. The method of adding the electronic signature to the sent data may be the same as what is described above.

In some implementations, electronic device 200 may include a user interface, and user 210 may directly send the access request through the user interface of electronic device 200.

In some implementations, user 210 may use a mobile device to send the access request to electronic device 200.

For example, user 210 may establish a connection with electronic device 200 and send an access request to electronic device 200 through a mobile device that has a wallet program, such as MetaMask installed.

In step S220, electronic device 200 may examine a right of user 210 to the digital token based on the access request. Specifically, the access request may indicate the digital token and its corresponding smart contract 130. Therefore, electronic device 200 may search for smart contract 130 to determine whether user 210 has the right to access the digital asset corresponding to the digital token.

In some implementations, user 210 may have the right to access the digital asset corresponding to the digital token if user 210 possesses the digital token; otherwise, user 210 may not have the right to access the digital asset corresponding to the digital token.

In some implementations, the access request may include user 210's wallet address, the token identifier of the digital token, and the address of the smart contract. Therefore, electronic device 200 may search for smart contract 130 based on its address to determine whether the wallet address of user 210 is associated with the token identifier according to the content of smart contract 130. Specifically, if the wallet address of user 210 is associated with the token identifier, it may indicate that user 210 possesses the digital token and has the right to access the digital asset corresponding to the digital token; otherwise, it may indicate that user 210 does not possess the digital token and does not have the right to access the digital asset corresponding to the digital token.

In some implementations, if electronic device 200 determines that user 210 has the right to access the digital asset corresponding to the digital token, it may obtain detailed information about the digital token corresponding to smart contract 130.

For example, the detailed information may include the contract number of smart contract 130, the wallet address of the owner of the digital token, the token identifier of the digital token, and information about the limitations of the digital token (e.g., such as the n/m format indicating the n^{th} token out of a total number of m tokens, n and m being positive integers).

In some implementations, electronic device 200 may first verify the electronic signature of user 210 and examine user 210's right to access the digital token based on the access request upon a successful verification.

In step S230, electronic device 200 may obtain the digital asset and the attestation result corresponding to the digital asset based on the examined right. Specifically, if electronic device 200 confirms that user 210 has the right to access the digital asset corresponding to the digital token, it may attempt to download the digital asset and its corresponding attestation result from database 120.

In some implementations, electronic device 200 may send a download request for the digital asset to database 120. In particular, electronic device 200 may add its own electronic signature to the download request. After receiving the download request, database 120 may first use the device's public key to verify the electronic signature of electronic device 200. If electronic device 200 fails to pass the verification, it may not be able to download the digital asset from database 120. Advantageously, this approach can effectively prevent piracy issues of electronic device 200 and prevent illegal acquisition of the digital assets.

In some implementations, the download request for the digital asset may be an access request with the electronic signature of user 210. After receiving the download request, database 120 may first use the user's public key to verify the identity of user 210 based on the electronic signature. If user 210 fails to pass the verification, electronic device 200 may not be able to download the digital asset from database 120.

In some implementations, electronic device 200 may add its own electronic signature to the access request with the electronic signature of user 210 to generate the download request for the digital asset. After receiving the download request, database 120 may use both the device's public key and the user's public key to verify the identity of both electronic device 200 and user 210 based on their respective electronic signatures. If any of electronic device 200 or user 210 fails to pass the verification, electronic device 200 may not be able to download the digital asset from database 120.

In some implementations, the download request may include information, such as the wallet address of user 210, the token identifier of the digital token, and the address of smart contract 130 corresponding to the digital token.

In some implementations, database 120 may record the number of downloads of the digital asset corresponding to the digital token to control the total number of downloads of the digital asset by the digital token. For example, when the total number of downloads of a particular digital asset by a digital token reaches a default limit, database 120 may reject any additional download requests that include the token identifier of the digital token.

In some implementations, the download request may also include the identifier of electronic device 200. Accordingly, database 120 may record the number of electronic devices that have downloaded and saved the digital asset for each digital token, to control the total number of electronic devices that have used the digital token to download and save the digital asset. For example, if the maximum number of electronic devices that can use a particular digital token to download the corresponding digital asset is n (n being a positive number), then database 120 may reject a new download request that includes the token identifier of the particular digital token from the (n+1)th electronic device. In this case, when an electronic device deletes the digital asset, it may send a notification message to database 120, so that database 120 may adjust the recorded number of electronic devices accordingly. The notification message may include the identifier of the electronic device.

In some implementations, database 120 may use an encrypted security protocol to send digital asset to electronic device 200 to protect the transmission of digital assets. For example, the encrypted security protocol may be the HyperText Transfer Protocol Secure (HTTPS), or any other security protocol.

In some implementations, the firmware and/or hardware of electronic device 200 may be designed to prevent digital assets that are downloaded from database 120 from being transmitted or copied outside of electronic device 200.

In step S240, electronic device 200 may use the attestation result to verify the obtained digital asset with blockchain 140 to obtain a verification result. Specifically, the verification result may include the authenticity of the digital asset obtained by electronic device 200.

In some implementations, the attestation result may include the identifier of the smart contract and the search key value. For example, electronic device 200 may obtain the smart contract from blockchain 140 based on the identifier of the smart contract and find the first operation result (e.g., hash value) of the specific operation corresponding to the search key value. Accordingly, electronic device 200 may use the same specific operation (e.g., calculate the hash value) on the digital asset it has obtained to obtain the second operation result. Then, electronic device 200 may compare the first operation result with the second operation result. If the first operation result and the second operation result are the same, the digital asset obtained by electronic device 200 may be authenticated; otherwise the digital asset obtained by electronic device 200 may not be authenticated.

In some implementations, the attestation result may include a slice of a binary tree. For example, electronic device 200 may send the attestation result to a third-party blockchain attestation platform to obtain the verification result. As mentioned above, the third-party blockchain attestation platform may be a platform that uses traditional technologies, such as the ones described in Taiwanese patent publication numbers 1783441, 1728899, 1708154, 1707573, 1706662, and the like.

In some implementations, the verification result may include a timestamp of the attestation and information of a party attesting the digital asset (e.g., a wallet address of the attester).

In some implementations, the verification result may include the creation history of the digital asset. For example, the creation history of the digital asset may be recorded in the smart contract which may be used for attestation when the digital asset is attested through the blockchain 140.

In step S250, electronic device 200 may determine whether to perform an operation corresponding to the digital asset based on the verification result. Specifically, if the verification result shows that the digital asset obtained by electronic device 200 is authentic, electronic device 200 may perform the operation corresponding to the digital asset. Conversely, if the verification result shows that the digital asset obtained by electronic device 200 is not authentic, electronic device 200 may not perform the operation corresponding to the digital asset.

In some implementations, the digital asset may include high-quality audio files, high-resolution artworks and/or animations, and the corresponding operation on electronic device 200 may include playing/displaying, or causing an external device to play/display, the high-quality audio files, high-resolution artworks and/or animations.

For example, electronic device 200 may have a display panel that may display a high-resolution artwork and/or animation in step S250.

In some examples, electronic device 200 may display a special color border while displaying a high-resolution artwork or animation to indicate that electronic device 200 is showing an authenticated limited digital asset.

In some examples, electronic device 200 may receive a signal to trigger the playing/displaying of (or at least some of) the detailed information and/or verification results corresponding to the digital token. Electronic device 200 may receive the signal, for example, through wireless transmission or physical buttons, but the present disclosure is not limited to such technic s.

In some implementations, the digital asset may include software, and the corresponding operation on electronic device 200 may include starting, or causing an external device, to launch the software.

In some implementations, the digital asset may include digital data corresponding to electronic device 200, such as a warranty certificate or a warranty record. The corresponding operation on electronic device 200, under such circumstances, may include enabling a specific function of electronic device 200.

For example, electronic device 200 may be a household appliance, and enabling a specific function of the household appliance may include making the household appliance operational.

As another example, electronic device 200 may be a motorcycle or a car. Enabling a specific function of the motorcycle may include unlocking the steering lock or starting the motorcycle, while enabling a specific function of the car may include unlocking the door lock or starting the car.

In some implementations, the digital asset may include digital data corresponding to an external device connected to electronic device 200, such as a warranty certificate or a warranty record. In such a case, the corresponding operation on electronic device 200 may include enabling a specific function of the external device.

For example, the external device may be a household appliance, and enabling a specific function of the household appliance may include making the household appliance operational.

As another example, the external device may be a motorcycle or a car. Enabling a specific function of the motorcycle may include unlocking the steering lock or starting the motorcycle, while enabling a specific function of the car may include unlocking the door lock or starting the car.

Advantageously, an ecosystem of data and asset synchronization transfer may be established in some implementations. In such an ecosystem, users may transfer the right to use the assets, such as audio and/or image playback rights, software usage rights, and device activation rights, by transferring the digital tokens.

It should be noted that in different example scenarios, the operations corresponding to the digital assets may be different. The present disclosure is not limited to the operations corresponding to the digital assets as described above.

In some implementations, the ownership of digital tokens may be transferred on the secondary market and/or using a blockchain browser.

For example, a first user may associated with a first wallet address, and a second user may be associated with a second wallet address. Since the first user owns a digital token with a first token identifier, the first token identifier may be associated with the first wallet address in the corresponding smart contract. If the first user (for example, on the secondary market or using a blockchain browser) transfers the ownership of the digital token with the first token identifier to the second user, then in the corresponding smart contract, the first token identifier may be modified to be associated with the second wallet address and not be associated with the first wallet address.

In some implementations, when performing the operation corresponding to the digital asset on electronic device 200, electronic device 20 may examine user 210's right to the digital token multiple times in a predetermined manner, and determine whether to cease performing the operation corresponding to the digital asset based on the examined right.

For example, when performing the operation corresponding to the digital asset on electronic device 200, the right of user 210 to the digital token may be examined periodically (e.g., every 30 seconds). If user 210 has transferred the digital token they own to someone else, then when electronic device 200 examines user 210's right to the digital token periodically, it may find that user 210 no longer has the right to access the digital asset corresponding to the digital token. Details of examining user 210's right to the digital token is described step S220 above.

For example, in a case that electronic device 220 determines that user 210 does not have the right to access the digital asset corresponding to the digital token, it may cease performing the operation corresponding to the digital asset. Therefore, once user 210 transfers the digital token they own to someone else, electronic device 200 that performs the operation corresponding to the digital asset (e.g., displaying the artwork), in response to user 210's access request, may cease performing the operation corresponding to the digital asset.

The following examples are given to illustrate the hardware architecture and non-transitory computer-readable medium that may implement the above methods.

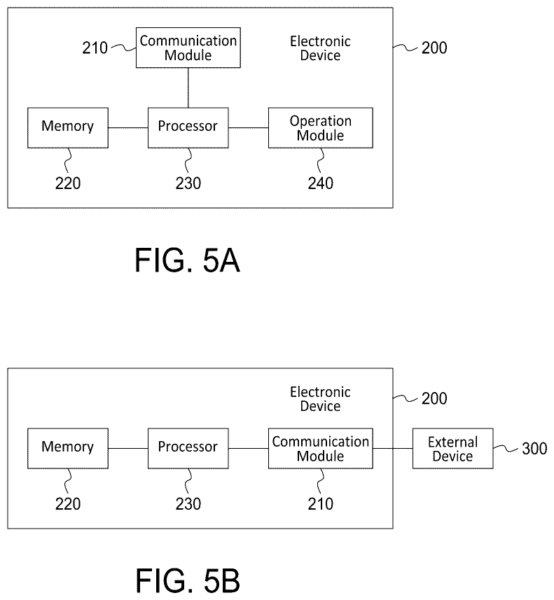

FIG. 5A is a block diagram illustrating an electronic device, according to an example implementation of the present disclosure. FIG. 5B is a block diagram illustrating an electronic device, according to another example implementation of the present disclosure.

Referring to FIG. 5A, electronic device 200 may have the ability to perform the operation corresponding to the digital asset by itself.

In some implementations, electronic device 200 may include communication module 210, memory 220, processor 230, and operation module 240, where processor 230 may be coupled to communication module 210, memory 220, and operation module 240. Communication module 210 may be configured to communicate with other devices via wired or wireless means. For example, communication module 210 may include input/output interfaces for wired communications. Alternatively, communication module 210 may include WiFi, Bluetooth, or other interfaces for wireless communications. Memory 220 may be configured to store at least one instruction. Processor 230 may be configured to control the overall operation of electronic device 200. Operation module 240 may be configured to perform operations corresponding to digital assets. For example, when a digital asset includes a painting or an animation, operation module 240 may include a display module for displaying such painting and/or animation. Conversely, when a digital asset includes an audio file, operation module 240 may include a speaker module for playing the audio file. As another example, when a digital asset includes documents related to electronic device 200, such as a warranty certificate or a warranty record, operation module 240 may include a boot module for booting the device. The present disclosure is not limited to the above described examples.

In some implementations, after processor 230 loads the at least one instruction from memory 220 an executes it, the digital asset access method described in the above implementations may be executed to determine whether to perform the operation corresponding to the digital asset. When processor 230 determines to perform the operation corresponding to the digital asset, the operation corresponding to the digital asset may be performed via operation module 240.

Referring to FIG. 5B, electronic device 200 itself may not need to have the ability to perform the operation corresponding to the digital asset. In such a scenario, external device 300 coupled to electronic device 200 may have the ability to perform the operation corresponding to the digital asset. For example, when the digital asset includes a painting or an animation, external device 300 may include a display panel; when the digital asset includes an audio file, external device 300 may include a speaker; when the digital asset includes documents related to external device 300, such as a warranty certificate or a warranty record, external device 300 may be a household appliance, a motorcycle, a car or other electronic products; etc.

In some implementations, electronic device 200 may include communication module 210, memory 220, and processor 230, where processor 230 may be coupled to communication module 210 and memory 220. Communication module 210 may be configured to communicate with other devices via wired or wireless means, or may be coupled to external device 300. For example, communication module 210 may include input/output interfaces for wired communications. Alternatively, communication module 210 may include WiFi, Bluetooth, or other interfaces for wireless communications. Memory 220 may be configured to store at least one instruction. Processor 230 may be configured to control the overall operation of electronic device 200.

In some implementations, after processor 230 loads the at least one instruction from memory 220 and execute it, the digital asset may access the methods described above and may perform these methods to determine whether to perform the operation corresponding to the digital asset. When processor 230 determines to perform the operation corresponding to the digital asset, a signal may be sent out via communication module 210 to trigger external device 300 to perform the operation corresponding to the digital asset.

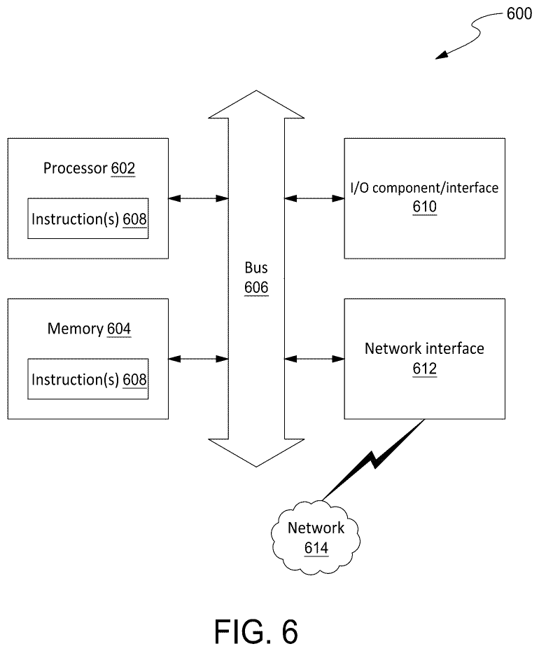

FIG. 6 is a schematic diagram illustrating an electronic device, according to an example implementation of the present disclosure.

FIG. 6 generically introduces electronic device 600, which can be implemented in the form of electronic device 100, database 120, or electronic device 200 mentioned in this article.

In some implementations, electronic device 600 may operate as an independent device or can be connected (for example, via a network) to other devices. In some cases, electronic device 600 may operate as a server or client in a server-client network environment, or as a peer in a peer-to-peer or distributed network environment.

For example, electronic device 600 may be any electronic product that has computing capabilities and can execute instructions to operate, such as a personal computer (PC), laptop, tablet, personal digital assistant (PDA), smartphone, set-top box, and so on. It should be noted that although only a single device is shown in FIG. 6, those skilled in the art should understand that the term “electronic device” can be understood to include any collection of devices that individually or collectively execute one or more instructions described and/or required in this article.

Referring to FIG. 6, electronic device 600 may include processor 602 and memory 604 that communicate with each other via bus 606 or other data transfer system. Electronic device 600 may also include various input/output components and/or interfaces 610 and network interface 612. In some implementations, network interface 612 may include one or more wireless transceivers that are configured to communicate using any one or more standard wireless and/or cellular protocols or access technologies.

Memory 604 may be a computer-readable storage medium. Memory 604 may store one or more instructions 608 that can implement the methods described in this article. During the operation of electronic device 600, the one or more instructions 608 or a portion thereof may also reside entirely or partially within processor 602, allowing processor 602 to execute the methods described in this article. Therefore, memory 604 and processor 602 may also constitute a computer-readable storage medium. Those skilled in the art should understand that the term “computer-readable medium” can be understood to include one or more non-transitory media that store one or more instructions (sets), including but not limited to solid-state storage devices, optical media, and magnetic media.

The modules and functional operations described in this article can be implemented using digital circuits, software, firmware, hardware, or any combination thereof.

In addition, the implementations described in this article may also be implemented as one or more computer program products, including a computer program having one or more instructions. Specifically, the computer program (also called a program, software, script, or code) can be presented in any form of programming language and can be deployed in any form. During the operation of electronic device 600, the one or more instructions or a portion thereof may also reside entirely or partially within processor 602, allowing processor 602 to execute the methods described in this article.

From the present disclosure, it is manifested that various techniques may be used for implementing the concepts described in the present disclosure without departing from the scope of those concepts. Moreover, while the concepts have been described with specific reference to certain implementations, a person of ordinary skill in the art would recognize that changes may be made in form and detail without departing from the scope of those concepts. As such, the described implementations are to be considered in all respects as illustrative and not restrictive. It should also be understood that the present disclosure is not limited to the particular implementations described above. Still, many rearrangements, modifications, and substitutions are possible without departing from the scope of the present disclosure.

What is claimed is:

1. A blockchain-based method for accessing digital assets applicable to an electronic device, the method comprising:
receiving an access request for a digital token corresponding to a digital asset from a user;
examining a right of the user to the digital token according to the access request;
obtaining the digital asset and an attestation result corresponding to the digital asset according to the right of the user;
verifying the obtained digital asset with a blockchain according to the attestation result to obtain a verification result; and
determining whether to perform an operation corresponding to the digital asset based on the verification result.

2. The method of claim 1, wherein obtaining the digital asset and the attestation result corresponding to the digital asset comprises:
sending a download request for the digital asset to a remote database, the download request comprising a first signature corresponding to the electronic device, wherein the first signature is configured to allow the remote database to verify the electronic device; and
downloading the digital asset and the attestation result corresponding to the digital asset from the remote database.

3. The method of claim 2, wherein:
the download request further comprises a second signature corresponding to the user, and
the second signature is configured to allow the remote database to verify an identity of the user.

4. The method of claim 1, further comprising, while performing the operation corresponding to the digital asset:
periodically examining the right of the user to the digital token; and
determining whether to cease performing the operation corresponding to the digital asset based on the right of the user.

5. The method of claim 1, wherein the access request indicates the digital token and a smart contract corresponding to the digital token, and examining the right of the user to the digital token according to the access request comprises:
determining whether the user possesses the digital token based on the smart contract and a wallet address corresponding to the user.

6. The method of claim 1, further comprising:
displaying detailed information corresponding to the digital token and the verification result, wherein the verification result comprises information of a party attesting the digital asset.

7. An electronic device, comprising:
a communication module;
a memory storing at least one instruction; and
a processor coupled to the communication module and the memory, wherein when the at least one instruction is executed by the processor, the processor causes the electronic device to:
receive an access request for a digital token corresponding to a digital asset from a user;
examine a right of the user to the digital token according to the access request;
obtain the digital asset and an attestation result corresponding to the digital asset according to the right of the user;
verify the obtained digital asset with a blockchain according to the attestation result to obtain a verification result; and
determine whether to perform an operation corresponding to the digital asset based on the verification result.

8. The electronic device of claim 7, wherein obtaining the digital asset and the attestation result corresponding to the digital asset comprises:
sending a download request for the digital asset to a remote database, the download request comprising a first signature corresponding to the electronic device, wherein the first signature is configured to allow the remote database to verify the electronic device; and
downloading the digital asset and the attestation result corresponding to the digital asset from the remote database.

9. The electronic device of claim 8, wherein:
the download request further comprises a second signature corresponding to the user, and
the second signature is configured to allow the remote database to verify an identity of the user.

10. The electronic device of claim 7, wherein while performing the operation corresponding to the digital asset, the processor is further configured to execute the at least one instruction to cause the electronic device to:
periodically examine the right of the user to the digital token; and
determine whether to cease performing the operation corresponding to the digital asset based on the right of the user.

11. The electronic device of claim 7, wherein the access request indicates the digital token and a smart contract corresponding to the digital token, and wherein examining the right of the user to the digital token according to the access request comprises:
determining whether the user possesses the digital token based on the smart contract and a wallet address corresponding to the user.

12. The electronic device of claim 7, further comprising:
a display module, coupled to the processor, and configured to display detailed information corresponding to the digital token and the verification result, wherein the verification result comprises information of a party attesting the digital asset.

13. A non-transitory computer-readable medium of an electronic device storing at least one instruction, wherein when the at least one instruction is executed by a processor of the electronic device, the processor causes the electronic device to:
receive an access request for a digital token corresponding to a digital asset from a user;
examine a right of the user to the digital token according to the access request;
obtain the digital asset and an attestation result corresponding to the digital asset according to the right of the user;
verify the obtained digital asset with a blockchain according to the attestation result to obtain a verification result; and
determine whether to perform an operation corresponding to the digital asset based on the verification result.

14. The non-transitory computer-readable medium of claim 13, wherein obtaining the digital asset and the attestation result corresponding to the digital asset comprises:
sending a download request for the digital asset to a remote database, the download request comprising a first signature corresponding to the electronic device, wherein the first signature is configured to allow the remote database to verify the electronic device; and
downloading the digital asset and the attestation result corresponding to the digital asset from the remote database.

15. The non-transitory computer-readable medium of claim 14, wherein:
the download request further comprises a second signature corresponding to the user, and
the second signature is configured to allow the remote database to verify an identity of the user.

16. The non-transitory computer-readable medium of claim 13, wherein when the at least one instruction is executed by the processor of the electronic device, the processor further causes the electronic device to:
periodically examine the right of the user to the digital token; and
determine whether to cease performing the operation corresponding to the digital asset based on the right of the user.

17. The non-transitory computer-readable medium of claim 13, wherein the access request indicates the digital token and a smart contract corresponding to the digital token, and examining the right of the user to the digital token according to the access request comprises:
determining whether the user possesses the digital token based on the smart contract and a wallet address corresponding to the user.

18. The non-transitory computer-readable medium of claim 13, wherein when the at least one instruction is executed by the processor of the electronic device, the processor further causes the electronic device to:
display detailed information corresponding to the digital token and the verification result, wherein the verification result comprises information of a party attesting the digital asset.
